(19) United States
(12) Patent Application Publication
(10) Pub. No.: US 2024/0102586 A1
(43) Pub. Date: Mar. 28, 2024

(54) FLEXIBLE STRETCH HOSE HAVING HOLLOW REINFORCING COILS AND PROPERTIES ENHANCED BY ANNEALING

(71) Applicant: GLOBALMED, INC., TRENTON (CA)

(72) Inventor: MARTIN E. FORRESTER, TRENTON (CA)

(73) Assignee: GLOBALMED INC., TRENTON (CA)

(21) Appl. No.: 18/529,904

(22) Filed: Dec. 5, 2023

Related U.S. Application Data
(63) Continuation-in-part of application No. 17/086,403, filed on Oct. 31, 2020, now Pat. No. 11,835,157.
Application No. 17/086,403 is a division of application No. 15/932,813, filed on Apr. 30, 2018, now Pat. No. 10,859,188.
Application No. 15/932,813 is a division of application No. 14/120,981, filed on Jul. 18, 2014, now Pat. No. 9,964,238.
Application No. 14/120,981 is a continuation-in-part of application No. 13/986,465, filed on May 6, 2013, now Pat. No. 9,308,698.
Application No. 13/986,465 is a continuation of application No. 12/799,263, filed on Apr. 21, 2010, now Pat. No. 8,453,681.
Application No. 12/799,263 is a continuation-in-part of application No. 12/354,291, filed on Jan. 15, 2009, now abandoned.
Application No. 14/120,981 is a continuation-in-part of application No. 13/507,172, filed on Jun. 11, 2012, now Pat. No. 9,505,164.
Application No. 14/120,981 is a continuation-in-part of application No. 13/987,837, filed on Sep. 6, 2013, now Pat. No. 9,365,004.
Application No. 13/987,837 is a continuation-in-part of application No. 13/986,465, filed on May 6, 2013, now Pat. No. 9,308,698.
(60) Provisional application No. 61/335,023, filed on Dec. 30, 2009.
(60) Provisional application No. 61/627,425, filed on Oct. 12, 2011.
(60) Provisional application No. 61/958,099, filed on Jul. 19, 2013.
(60) Provisional application No. 61/958,223, filed on Jul. 23, 2013.

(51) Int. Cl. F16L 11/112; B29D 23/18

(52) U.S. Cl. CPC F16L 11/112; B29D 23/18; B29C 2071/022

(57) ABSTRACT

A method of forming a flexible, stretchable, crush resistant axially extending hose includes: providing coils entirely of thermoplastic material to form a continuous and hollow helix; providing a thin, narrow, elongate web of thermoplastic material that extends between adjacent coils of the helix and has edge regions welded to adjacent ones of the coils to form a single continuous wall with the web having a centrally located fold situated between adjacent ones of the coils; and subjecting the hose to an annealing process while axially compressing the hose so that molecules of the thermoplastic material forming the coils of the helix and the thin elongate web are relaxed such that stress is substantially absent from the hose when the coils of the helix are close together.

### CROSS-REFERENCE TO RELATED APPLICATIONS

This application is a continuation-in-part of application Ser. No. 17/086,403 filed Oct. 31, 2020 (Atty's Dkt. No. 6-984); which is a division of application Ser. No. 15/932,813 filed Apr. 30, 2018 (Atty's Dkt. No. 6-983—since issued as U.S. Pat. No. 10,859,188); which is a division of application Ser. No. 14/120,981 filed Jul. 18, 2014 (Atty's Dkt. No. 6-982—since issued as U.S. Pat. No. 9,964,238); the entireties of each of which are incorporated herein by reference in their entireties for all purposes.

Said application Ser. No. 14/120,981 claims the benefit of the filing dates of two provisional applications, namely: Ser. No. 61/958,223 filed Jul. 23, 2013 (Atty's Dkt. 6-862); and Ser. No. 61/958,099 filed Jul. 19, 2013 (Atty's Dkt. 6-865); the entireties of both of which are incorporated herein by reference in their entireties for all purposes.

Said application Ser. No. 14/120,981 is also a continuation-in-part of application Ser. No. 13/986,465 filed May 6, 2013 (Atty's Dkt. No. 6-459—since issued as U.S. Pat. No. 9,308,698); which is a continuation of application Ser. No. 12/779,263 filed Apr. 21, 2010 (Atty's Dkt. No. 6-451—since issued as U.S. Pat. No. 8,453,861); which is a continuation-in-part of application Ser. No. 12/354,291 filed Jan. 15, 2009 (abandoned); and which claims benefit of the filing date of provisional application Ser. No. 61/335,023 filed Dec. 30, 2009 (Atty's Dkt. No. 6-450); the entireties of each of which are incorporated herein by reference in their entireties for all purposes.

Said application Ser. No. 14/120,981 is also a continuation-in-part of application Ser. No. 13/507,172 filed Jun. 11, 2012 (Atty's Dkt. No. 6-548—since issued as U.S. Pat. No. 9,505,164); which is a continuation-in-part of the aforementioned application Ser. No. 12/799,263; and which claims the benefit of the filing date of provisional application Ser. No. 61/627,425 filed Oct. 12, 2011 (Atty's Dkt. No. 6-546); the entireties of each of which are incorporated herein by reference in their entireties for all purposes.

Said application Ser. No. 14/120,981 is also a continuation-in-part of application Ser. No. 13/987,837 filed Sep. 6, 2013 (Atty's Dkt. No. 6-861—since issued as U.S. Pat. No. 9,365,004); which is a continuation-in-part of the aforementioned application Ser. No. 13/986,465; the entireties of both of which are incorporated herein by reference in their entireties for all purposes.

### FIELD OF THE INVENTION

The present invention relates to the production of an improved form of flexible, extensible and retractable corrugated hose of a type known commonly known as a “stretch hose” or “stretchable/retractable hose” that is formed from helically wound thermoplastic material(s).

More specifically, the present invention relates to an improved form of stretch hose that has adjacent pairs of reinforcing coils connected by a web of thermoplastic material. As will be explained in greater detail, when some embodiments of the hose are in a condition of minimal axial length, the web may join with adjacent reinforcing coils near their minimum inner diameters, and may extend radially outwardly therefrom so that the web that connects each adjacent pair of reinforcing coils is sandwiched between the pair of adjacent reinforcing coils. Alternatively, when other embodiments of the hose are in a condition of minimal axial length, the web may join with adjacent reinforcing coils near their maximum outer diameters, and may extend radially inwardly therefrom so that the web that connects each adjacent pair of reinforcing coils is again sandwiched between the pair of adjacent reinforcing coils.

The present invention also relates to a hose production method, namely to a method of production of helically reinforced flexible, extensible and retractable hose from newly extruded thermoplastic materials that are wound onto a rotating mandrel, followed by annealing of the hose in a fully axially contracted position.

### BACKGROUND

Some prior crush resistant plastic hose proposals call for the use of solvents or glues to bond a web of thin material to coils of a helix that cooperate with the web to give the resulting hose its crush resistance. However, the use of solvents in the manufacture of crush resistant hoses is undesirable in medical applications because the resulting hoses may bring the patient into contact with trace amounts of the manufacturing solvent or glue, or the solvent or glue may react undesirably with medication being administered through the hose to a patient.

Some prior crush resistant plastic hose proposals intended for medical use are produced by extruding a thin web of plastic material to provide a connecting wall extending between adjacent coils of a helix of plastic. This connecting web may take a wavy form or may incorporate accordion-like folds that enable the hose to extend and contract in an accordion-like manner to give the resulting hose a measure of flexibility.

Although the hoses that result from the process just described may be effective in delivering air or gas-borne substances to the patient, the nature of the extrusion process used to produce these hose products typically causes the resulting hoses to exhibit a high degree of torsional stiffness and a diminished degree of flexibility due to the orientation of the molecules that form not only the thin wavy wall but also the helix that enhances the crush resistance of the hose. The torsional stiffness can cause a patient's face mask or nasal mask to lift off the face during movements of the patient's head, thereby allowing unwanted ambient air to enter the breathing circuit during therapy. The stiff nature of existing products also may cause undesirable stress on a tracheotomy tube during patient movement, and can render difficult head movements of a patient.

### BRIEF DESCRIPTIONS OF THE DRAWINGS

A fuller understanding of the invention may be had by referring to the following description, taken together with the accompanying drawings, wherein:

FIG. 1 is a perspective view showing a length of one embodiment of flexible, stretchable, crush resistant hose embodying features of the present invention, with the hose in its fully axially contracted condition (i.e., fully axially retracted to its minimum axial length) wherein radially outwardly extending portions of a thin, extruded web of plastic material that extends between coils of a crush resistant plastic helix of the hose are snugly sandwiched between adjacent side-by-side coils of the helix;

FIG. 2 is a side elevational view of the hose length of FIG. 1, with the flexible hose in its fully axially contracted condition;

FIG. 3 is a right end view of the hose length of FIG. 1;

FIGS. 4 and 5 are sectional views of two variants of the hose length of FIG. 1, on an enlarged scale, as seen from a plane indicated by a line 4-4 in FIG. 3, showing a portion of the length of flexible hose in a slightly less than fully axially contracted condition, with a left portion of the view illustrating how the thin, extruded web of plastic material has its opposite edge regions extending inside flat interior surfaces defined by the coils of the helix just prior to when the edge regions are welded by an application of heat energy to the flat interior surfaces of the coils of the helix, and with a right portion of the view showing how the cross-section changes once the welding or bonding of the web edge regions to the coils of the helix has taken place, causing the thin, extruded web and the coils of the helix to form an integral hose product, with FIG. 4 showing a variant with a solid helix and FIG. 5 showing a variant with a hollow helix;

FIGS. 6 and 7 are a cross-sectional view of the two variants of the hose length of FIGS. 4 and 5, respectively, similar to FIGS. 4 and 5, respectively, but showing a portion of the length of flexible hose product in an axially extended condition.

FIG. 8 is a side elevational view showing the exterior of a short length of another embodiment of flexible, stretchable, crush resistant hose embodying features of the present invention, with the hose shown in its fully axially contracted condition;

FIG. 9 is an end view, on a reduced scale, of the hose length of FIG. 6;

FIG. 10 is a sectional view of the hose length of FIG. 6, as seen from a plane indicated by a line 10-10 in FIG. 7;

FIG. 11 is an enlargement of a selected circled portion of the sectional view of FIG. 10, showing that radially inwardly extending portions of a thin, extruded web of plastic material are snugly sandwiched between each adjacent pair of side-by-side reinforcing coils of the helix of the hose of FIG. 6 when in its fully axially contracted condition;

FIGS. 12 and 13 are sectional views of two variants of the hose length shown of FIG. 8, similar to FIG. 10, but with the hose length partially axially extended to an increased length, with FIG. 12 showing a variant with a solid helix and FIG. 13 showing a variant with a hollow helix;

FIG. 14 is a sectional view of a short length of still another embodiment of flexible, stretchable, crush resistant hose embodying features of the present invention, with the hose shown in its fully axially contracted condition (i.e., fully axially retracted to its minimum axial length), with portions of the thin cover of the web of the hose (which extends between and continuously connects each adjacent pair of the reinforcing coils of the hose) sandwiched between adjacent pairs of the helical coils of the hose length;

FIG. 15 is an enlargement of a small area designated by an oval in FIG. 14, showing how innermost portions of the thin cover of the web preferably are folded to underlie coils of the helix when the hose length of FIG. 14 is retracted to its minimum axial length; and

FIGS. 16 and 17 are schematic depictions of two variants of a hose production station, showing how a freshly extruded tape-like, relatively wide yet thin web of thermoplastic material and a freshly extruded bead of thermoplastic material are concurrently helically wrapped around a rotating mandrel to form a substantially endless length of corrugated hose which has reinforcing coils formed by the helically wrapped bead, a cover or outer wall formed by the helically wrapped web (e.g., the length of hose of at least either of FIG. 8 or 14) with adjacent pairs of the reinforcing coils having their peripheries bonded to edge regions of the web wraps, with an arrow indicating a direction of precession followed by the newly formed hose as it travels axially along the rotating mandrel, and FIG. 16 showing a variant with a solid helix and FIG. 17 showing a variant with a hollow helix

### DETAILED DESCRIPTION

The present invention relates to a flexible and easy-to-stretch hose that is crush resistant and well suited to provide a constant supply of air, anesthesia gas or gas-carried medication to a patient's face mask, nasal mask or tracheotomy tube for a variety of purposes such as anesthesia, life support or medication delivery, or to help prevent sleep apnea. Flexible, stretchable, crush resistant hoses embodying features of the invention are also well suited to evacuate gaseous pollutants from surgical areas, such as the removal of smoke during laser surgery.

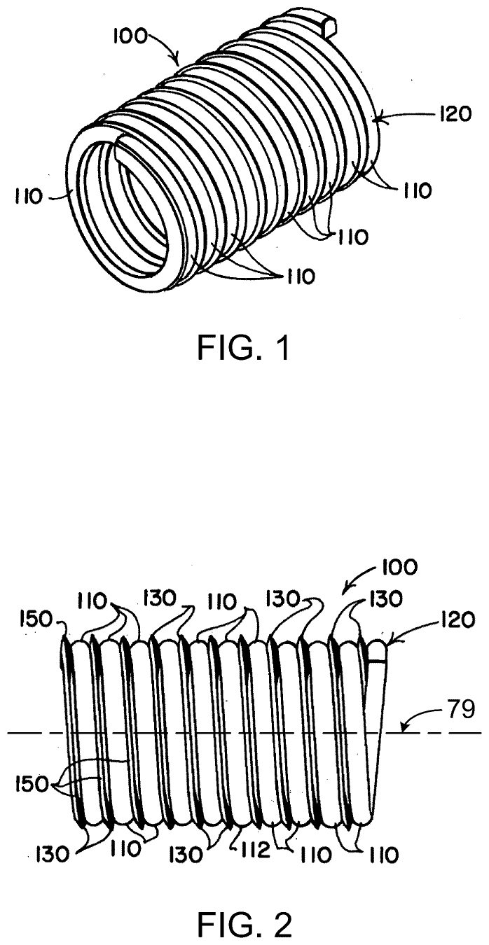

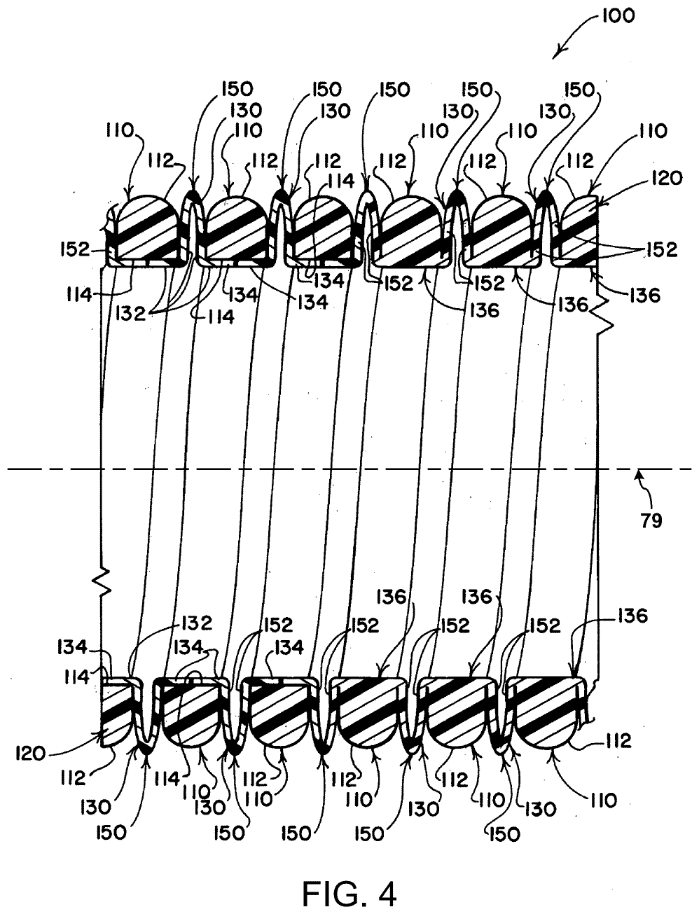

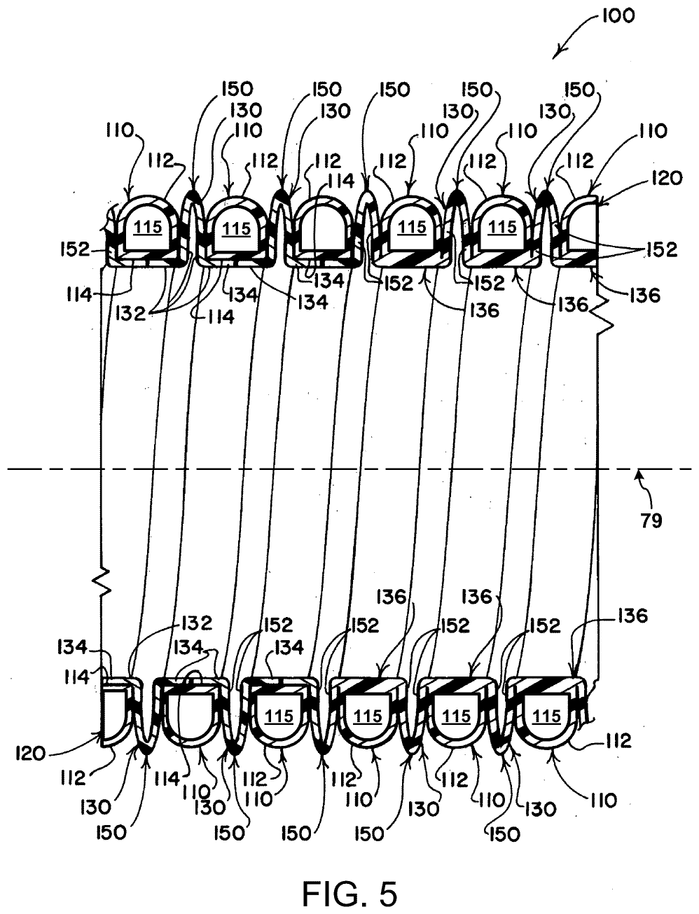

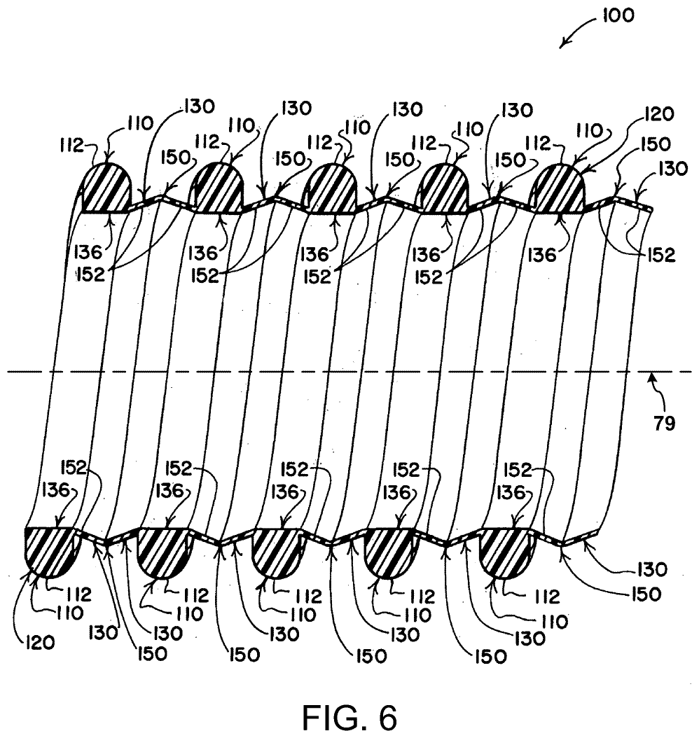

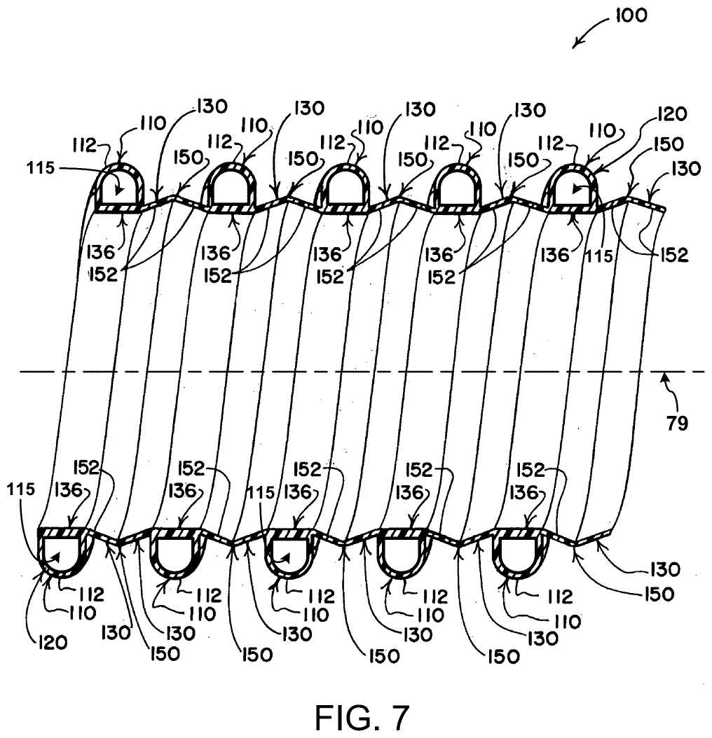

Referring to FIGS. 1-7, both of two variants of a length of flexible, stretchable, crush resistant hose embodying features of the present invention are indicated generally by the numeral 100. The hose 100 has coils 110 of a relatively stiff plastic material that form a helix 120, and has a thin web or wall 130 of plastic material that extends between the coils 110 of the helix 120. FIGS. 4 and 6 depict the helix 120 of one of the two variants as being solid such that the helix 120 has a substantially uniform cross-section. FIGS. 5 and 7 depict the helix 120 of the other of the two variants as being hollow.

The hollow helix 120 of the variant of FIGS. 5 and 7 serves to provide a secondary passage 115 to augment the primary passage that is defined by the hose 100 along the axis 79. The secondary passage 115 may be used to perform a number of functions in connection with the primary passage. For example, the secondary passage 115 may be used to convey a gas or liquid of controlled temperature as an approach to heating or cooling a gas or liquid that is conveyed through the primary passage. Alternatively or additionally, the secondary passage 115 may be used to provide a return path by which at least a portion of a flow of gas or liquid conveyed in one direction through the primary passage of the hose 100 may be conveyed in the opposite direction through the secondary passage 115. Also alternatively or additionally, the secondary passage 115 may be used to convey a gas or liquid that differs from the gas or liquid conveyed by the primary passage, and that is to be mixed with the gas or liquid that is conveyed by the primary passage at a location to which both are being conveyed.

As yet another example, the primary passage and the secondary passage 115 may be used together to provide a bi-directional flow in which a first gas or liquid is conveyed in one direction (along the axis 79) by the primary passage, while another gas or liquid is conveyed in the opposite direction by the secondary passage 115. More specifically, it may be that oxygen, moistened air and/or a medicated gas may be conveyed to a patient through the primary passage for inhalation, while exhaled gases may be conveyed away from the patient through the secondary passage 115. Still other uses for the secondary passage 115 will occur to those skilled in the art.

Although the hose 100 can undoubtedly be formed in a variety of ways, a preferred manufacturing technique employed during manufacture calls for the materials that form the coils 110 of the helix 120 and the thin web or wall 130 to be extruded, either concurrently as separate extrusions of the helical coils 110 and the thin web or wall 130 that are promptly bonded or welded together while still hot following extrusion, or as a single extrusion that forms the helical coils 110 together with an integral reach of thin web or wall 130 that also is welded or bonded promptly while still hot to form the hose 100.

What is referred to by use herein of the terms “welded,” “bonded,” “welding” and “bonding” is a joining together, in a heated environment or as a result of an application of heat energy (whether applied by radiation, convection, the use of laser-generated light or any other known or yet to be developed technique, or a combination thereof) of thermoplastic materials from which components of the hose 100 may be formed, including but not limited to PVC, TPU, PP, TPE, ABS and other thermoplastic materials and reasonable equivalents thereof, to form what results in or amounts to an integral assembly that typically exhibits no remaining borders between adjacent portions of the bonded or welded materials. In essence, the terms “welded” and “bonded,” and the terms “welding” and “bonding” are used interchangeably, with no differences of meaning intended therebetween.

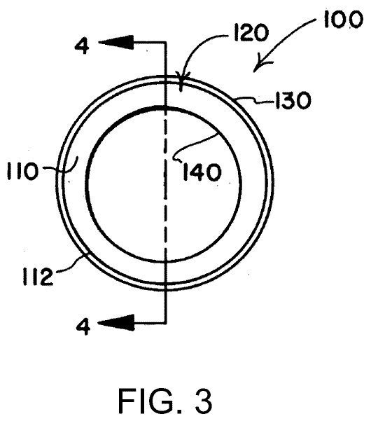

As depicted in FIGS. 1 and 2, when the flexible, stretchable, crush-resistant hose 100 is in its fully axially contracted condition (i.e., fully contracted along a axis 79), the coils 110 of the helix 120 become situated side-by-side such that they relatively snugly sandwich radially outwardly extending portions 152 (FIG. 4) of the thin plastic web or wall 130 therebetween. The hose 100 may have its minimum axial length when it is in its normal condition as depicted in FIGS. 1 and 2, but can also be axially stretched or extended (i.e., along the axis 79), as shown in FIG. 5, which causes the coils 110 of the helix 120 to separate, and causes the outwardly extending portions 152 of the thin web or wall 130 to flatten out or “unfold” in the manner depicted in FIG. 5. If, during axial stretching or extension, the hose 100 is caused to bend or deflect (from any of the linear or straight-line configurations that are depicted in FIGS. 1, 2, 4 and 5), the crush resistant character of the hose 100 will permit the bending or deflection to take place without significantly diminishing the inner diameter (designated by the numeral 140 in FIG. 3) of the hose 100.

As depicted, the coils 110 of plastic material that form the helix 120 may have either a uniform cross-section (again, see FIGS. 4 and 6) or a hollow cross-section (again, see FIGS. 5 and 7) that features a rounded exterior surface 112 and a substantially flat interior surface 114. When the substantially flat interior surface 114 is viewed from an end of the length of hose 100, as is depicted in FIG. 3, it will be seen to take the form of a circle which defines the interior diameter 140 of the hose 100. These circles defined by all of the coils 110 are substantially the same diameter.

Referring to the left “half” of both FIGS. 4 and 5, the thin web or wall 130 that extends between adjacent pairs of the coils 110 is preferably formed by extruding a thin, flat, elongate, tape-like or band-like web of plastic material 132 that ultimately has its opposite edge regions 134 bonded or welded to the flat interior surfaces 114 of the coils 110. As is shown somewhat schematically in the left “half” of FIGS. 4 and 5, the edge regions 134 of the thin wall or web 130 each preferably extend about halfway into and along the flat interior surfaces 114 of the coils 110—at which locations the edge regions 134 are welded or bonded to the flat surfaces 114 by an application of heat energy to form an integral hose 100, in a manner that is depicted in the right “half” of FIG. 4.

In essence, such boundaries as exist between the edge regions 134 and the flat interior surfaces 114 (as depicted in the left “half” of FIGS. 4 and 5 at a time before welding or bonding takes place) effectively “disappear” as the thermoplastic materials forming the coils 110 and the web edge regions 134 merge and integrally bond during welding or bonding to form the integral hose product 100 that is shown in the right “half” of FIGS. 4 and 5.

If identical thermoplastic materials are used to form the coils 110 of the helix 120 and the thin web or wall 130, the hose 100 that results when a proper thermoplastic welding or bonding process has been completed is a one-piece member with no discernible borders or boundaries.

If, on the other hand, different thermoplastic materials (for example a material used to form the coils 110 of the helix 120 that has a higher modulus of elasticity than does a material used to form the thin web or wall 130) are separately extruded and properly thermoplastically welded or bonded to form the hose 100, the material of the web or wall 130 may provide a contiguous, continuous and uninterrupted liner that shields the material of the coils 110 of the helix 120 from contact with gases and the like that flow through the inner diameter 140 of the hose 100—which, in certain medical applications may be of importance to prevent interactions between the material forming the coils 110 of the helix 120 and certain medications being carried by gases flowing through the hose 100.

To enhance the stretchability and flexibility of the hose 100 without diminishing its crush resistance, and to thereby avoid the problems of stiffness that are characteristic in many of the crush resistant hoses of prior proposals, the bonded or welded hose product 100 is subjected to an annealing process that modifies the orientation of the molecules of thermoplastic that forms the coils 110 of the helix 120 and the thin wall or web 130 that extends between the coils 110 of the helix 120.

When the hose 100 initially is formed, the coils 110 of the helix 120 are relatively widely spaced, and the thin web of plastic material that extends between adjacent pairs of the coils 110 takes a cylindrical shape that does not project radially outwardly at locations between the coils 110 of the helix 120. However, as the annealing process is carried out, the coils 110 of the helix 120 are moved closer and closer toward each other, which causes the web 130 situated between adjacent pairs of the coils 110 to bulge radially outwardly, creating the radially outwardly extending portions 152. As the elements of the hose 100 come to the axially contracted condition depicted in FIGS. 1 and 2, wherein the coils 110 assume side-by-side positions snugly sandwiching the radially outwardly bulging web 130 therebetween, a reverse-direction crease or fold 150 (see FIGS. 4 through 7) is caused to form and set at a central location extending along the length of the tape-like or band-like web or wall 130.

As the heating and controlled cooling of the annealing process is completed with the hose 100 in its minimum axial length condition (as depicted in FIGS. 1 and 2), the molecules of the material of the coils 110 and the web or wall 130 relax and take on a new orientation with a memory of the minimum axial length condition of the completed hose 100 becoming its “normal condition” to which the hose 100 will normally return when released from the imposition of external forces (including the force of gravity). And, because stress is substantially absent from the hose 100 when the coils 110 of the hose 100 are side-by-side compressing the radially extending web or wall portions 152 therebetween (i.e., when the hose 100 is in its minimum axially contracted “normal condition” as depicted in FIGS. 1 and 2), the hose 100 begins resisting extension only when, and to the extent that, the hose 100 is stretched causing it to lengthen.

Stated in another way, the annealing process to which the hose 100 (either the variant of FIGS. 4 and 6, or the variant of FIGS. 5 and 7) is subjected allows the hose 100 to exhibit a greater degree of flexibility and an ease of being stretched than are exhibited by conventional, non-annealed hose products, and enables the hose 100 to, in effect, provide a “strain relief” between medical delivery equipment (not shown) that typically is connected to one end region of a length of the hose 100, and a patient's facial or nasal mask (not shown) that typically is connected to an opposite end region of the same length of hose 100 in medical applications that often make use of the hose 100.

Yet another benefit of the annealed and stress-relieved hose 100 (which results from stresses that were introduced during the manufacture of the hose 100 being relieved during annealing) is that the stress-relieved hose 100 does not take a set shape (i.e., does not take on a configurational memory to which the hose 100 seeks to return) when deflected or bent in any one direction or orientation for a lengthy period of time.

When the hose 100 is in its fully axially contracted condition, as is depicted in FIGS. 1 and 2, the centrally located reverse-direction crease or fold 150 that is set in the thin tape-like or band-like web or wall 130 is located radially outwardly beyond the rounded exterior surfaces 112 of the coils 110 that form the helix 120 (a feature best seen in FIGS. 4 and 5 for each of the two variants). The length of the radially outwardly extending portions 152 of the web 130 (that extend from the inner diameter 140 of the hose 100 to the reverse-direction creases or folds 150 that define the outer diameter of the hose 100) provides the web or wall 130 with a greater surface area to displace during flexure of the hose 100 (than typically is found in present day hoses utilized to deliver air, medicinal gases and the like in today's medical environments)—which also helps to enhance the flexibility of the hose 100.

A feature of the hose 100 is its extensibility (i.e., the ease with which the hose 100 can be stretched). The length of the radially outwardly extending portions 152 of the web 130, and the accordion-like reverse-direction crease or fold 150 that extends radially outwardly of the curved outer surfaces 112 of the coils 110 of the helix 120 gives the hose 100 an impressive ability to extend when a patient situated near one end of a reach of the hose 100 moves relative to a medical apparatus connected to an opposite end of the reach of hose 100—which is to say that the hose 100 provides a “strain relief” that minimizes the transmission of force along the length of the hose 100.

What a length of the hose 100 offers is an ability to stretch (as depicted in FIGS. 6 and 7 for each of the two variants) to a length of at least about one and a half times the length that is exhibited by the hose when at rest in its “normal” fully axially contracted condition (as is depicted in FIGS. 1 and 2). This extensibility characteristic represents a significant improvement in comparison with the more limited extensibility offered by other present day crush resistant hoses.

When the hose 100 is extended in the manner depicted in FIGS. 6 and 7, the memory of the hose 100 provides a gentle spring effect that will tend to return the hose 100 to its fully axially contracted condition (i.e., its “normal condition” as depicted in FIGS. 1 and 2) when the force causing the hose to extend diminishes and/or is no longer exerted on the hose 100. This gentle spring effect is unlike the forceful resistance to stretching or extension that is often encountered with other present day crush resistant hoses used to deliver gases in medical applications.

When the hose 100 is extended (for example, in the manner depicted in FIGS. 6 and 7 for both variants), the radially extending portions 152 and the reverse-direction creases or folds 150 of the web or wall 130 are pulled radially inwardly—but not in a way that diminishes the interior diameter 140 (labeled in FIG. 3) of the hose 100 that exists after the web 130 and the coils 110 of the helix 120 are bonded or welded to form the integral hose product that is depicted in the right “half” of each of FIGS. 4 and 5 wherein the edge regions 134 shown in the left “half” of each of FIGS. 4 and 5 (at a time prior to bonding or welding) have become integrally bonded or welded to the coils 110 of the helix 120.

In one preferred embodiment of either of the two variants of the hose 100, the spring tension that tends to cause the hose to retract to the normal condition builds up in the hose only when the hose is stretched, and the spring tension attributable to the thermoplastic material forming the web in proportion to the spring tension attributable to the thermoplastic material forming the coils of the support spiral is at least about 25% to at least about 50%; and, in some embodiments of either of the two variants, this ratio may be at least about 25% to as high as at least about 90%.

In one preferred embodiment of either of the two variants of the hose 100, the helix 120 and the web 130 are formed from the same thermoplastic copolyester elastomer, also known as TPC-ET. One suitable example of a TPC-ET material well suited to form the hose 100 is sold by E.I. Dupont de Nemours & Company under the registered trademark HYTREL—the torsional stiffness of which can be relieved by heating the welded hose 100 during the aforedescribed annealing process. The stress relieved hose 100 that results once the annealing process is completed is of continuously wound, heat welded, thermoplastic construction, and uses no solvents or glues to bond or weld the plastic helix 120 to the edge regions 134 of the thin web or wall 130 at locations along the flat inner surfaces 114 of the coils 110 of the helix 120.

Hoses 100 embodying such features as are described herein can be produced in sizes a small as 0.315 inch inside diameter, making the hose 100 ideal for medical applications where lightweight, small diameter hoses are needed.

An objective of the annealing process to which the hose 100 is subjected is to diminish torsional stiffness of the resulting hose. Torsional stiffness is defined as how much twisting force is transmitted through the hose 100 before it “breaks away” into an arc or spiral that will absorb additional twisting force when one end is held securely to a fixed point. This could also be regarded as the “twisting yield point.”

For example, when a nurse moves a piece of life support equipment connected to a patient with a hose of high torsional stiffness, a great deal of the movement is transmitted through the hose to the patient interface, which creates a potential for the interface to leak or become disconnected from the patient. However, a hose with low torsional stiffness used in the same situation will “break away” into an arc or spiral thereby reducing the force that is transmitted to the patient interface, which is less likely to cause a face mask or the like to be moved from properly engaging the face of a patient.

The torsional stiffness of a hose can be determined quantitatively by measuring the amount of force required to cause a length of the hose of approximately five to ten times the internal diameter of the hose to “break away” from alignment with an axis that extends centrally through the hose (i.e., the axis 79), with one end of the hose under test being connected to a torque measuring device, and with the other end being turned in a direction opposite to that of the wind of the helix of the hose. The aforedescribed annealing process to which the hose 100 is subjected serves to diminish torsional stiffness by at least about 20 percent when compared with other hoses used in medical applications.

A hose 100 of either of the two variants, and embodying features of the present invention, can be formed using a two step manufacturing process. A first step is to continuously wind a molten plastic (preferably a thermoplastic copolyester elastomer) profile in the shape of both the thin wall 130 and the helix 120 portions of the hose 100 around a series of spinning mandrels that are angled to allow the profile to progress forwardly off of the mandrels. The angle is controlled to insure there is a sufficient bond of the edge regions 134 of tape-like thin wall 130 to the flat inside surfaces 114 of the coils 110 of the helix 120. The angle provides the necessary pitch of helix spacing, which may be two to five times the final dimension of the resulting hose 100 after the aforedescribed annealing process.

A second step is to anneal the hose 100. As previously described, this may entail compressing the hose 100 axially (i.e., along the axis 79), and placing the hose 100 in an oven at a temperature below the melting temperature of the plastic material that forms the hose 100, for enough time 1) to relieve such stress as was introduced during the extrusion process, and 2) to cause the crease or fold 150 to be set into the thin wall 130 of the hose 100. The hose 100 is then removed from the oven, whereafter the hose 100 is cooled in a controlled manner and flexed to ensure that the desired degree of flexibility has been achieved.

Although a thermoplastic copolyester elastomer (TPC-ET) material such as Dupont HYTREL is a preferred material from which to form all components of the hose 100, the helix 120 and the web 130 components of the hose 100 may be formed from different thermoplastic materials, or from thermoplastic materials that differ from TPC-ET. Either or both of the helix 120 and the web 130 that connects adjacent coils 110 of the helix 120 may, for example, be formed from PVC, TPU, PP, TPE or ABS thermoplastic, or from any other commercially available thermoplastic polymers or blends thereof.

When the same TPC-ET material is used to form both the helix 120 and the web 130, the helix 120 and the web 130 can be extruded from a single die. TPC-ET is desirable for use in forming the hose 100 when the hose 100 is to be used in medical applications because the TPC-ET can be steam autoclaved to sterilize the hose 100, as is desirable (or even necessary) in medical environments.

TPC-ET material is naturally clear or translucent in thin cross-sections, such as are employed in forming the web 130 of the hose 100, and becomes opaque in thicker sections such as are employed in forming the helix 120, at least where the helix 120 is formed to be solid (as depicted in FIGS. 4 and 6). Thus, even though the same TPC-ET material may be used to form the web 130 and the helix 120 of the hose 100, the resulting hose 100 will likely have the appearance of being formed from two different materials. However, if the helix 120 is formed to be hollow (as depicted in FIGS. 5 and 7), then the helix 120 may also be clear or translucent such that the resulting hose 100 will likely have the appearance of being formed entirely from the same material.

Alternatively, the hose 100 may be formed from two different materials in order to create a totally transparent hose (even where the helix 120 is formed to be solid), or to create a two color hose, or to create a clear walled hose that has a specific colored helix—which may be desirable in order to “color code” particular reaches of the hose 100 so they will be consistently used to deliver only particular gases or gaseous mixtures to patients. Colorants can, of course, be added to any of the plastic materials used to form the hose 100 to achieve practically any desired color combination.

Materials having different characteristics such as a different hardness can be used to form the web or wall 130 and the coils 110 of the helix 120, which may involve the use of two separate extruders and either a co-extrusion die, or separate dies to create the web 130 and helix 120 separately, whereafter they are welded or bonded. Likewise, materials that have different moduli of elasticity may be used to form the web or wall 130 and the coils 110 of the helix 120—with, for example, the material forming the coils 110 of the helix 120 having a higher modulus of elasticity than the material forming the web or wall 130, to enhance the crush resistance of the resulting hose 100.

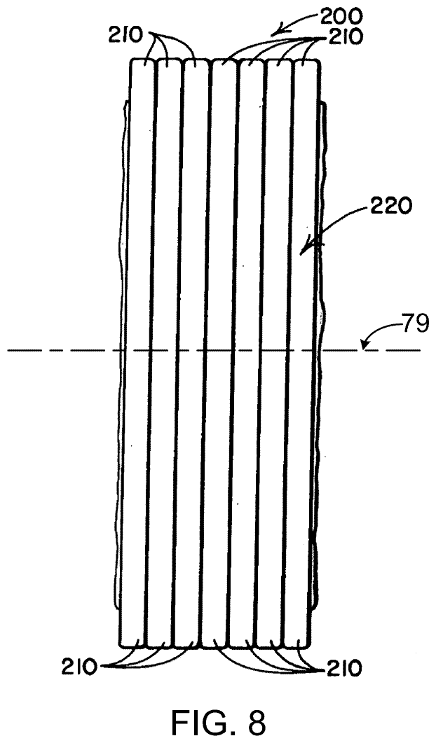

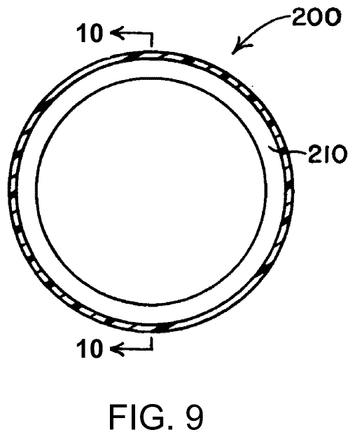

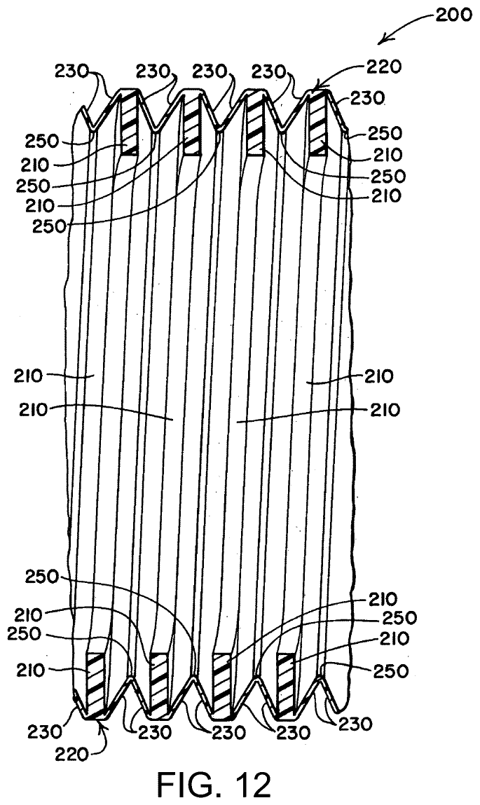

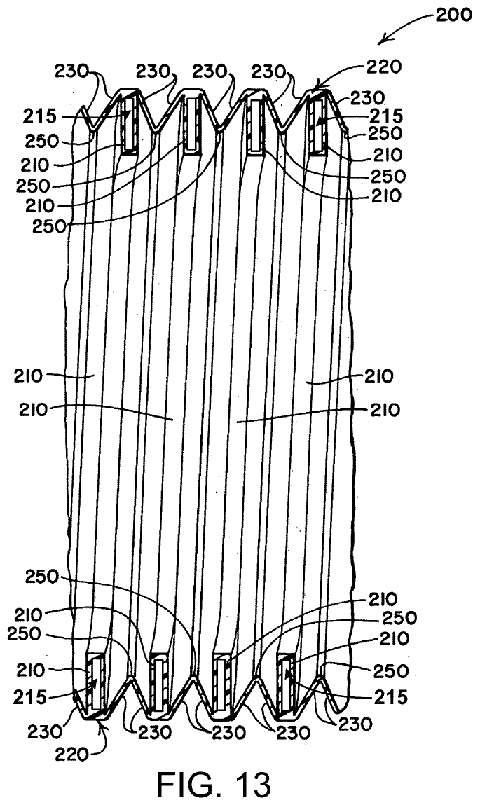

Referring to FIGS. 8-13, both of two variants of a short segment, reach or length of a stretch hose embodying features of the present invention are indicated generally by the numeral 200. Unlike the aforedescribed hose length 100, the hose length 200 has radially inwardly extending web portions 230 (best seen for both variants in FIGS. 12 and 13) that extend between and connect each adjacent pair of reinforcing coils 210 of a helix 220. Also unlike the aforedescribed hose length 100, when the hose length 200 is axially retracted to its minimum length (as shown in FIGS. 8-11), the web portions 230 of the hose length 200 are sandwiched between each pair of adjacent reinforcing coils 210 and (as depicted for both variants in FIGS. 12-13) may be sized and formed to not extend inwardly beyond the inner diameters of the reinforcing coils 210.

A problem that arises from time to time with the previously described hose lengths 100 is that the outermost crease or fold portions 150 of the thin web portions 130 are subject to wear as the hose length 100 moves about during use, and can sometimes result in puncture or failure of the hose length 100 to maintain its gas-tight and/or fluid-tight integrity, which can permit loss of such gas and/or fluid as is being transmitted from place to place by the hose length 100.

Conversely, a feature of the hose length embodiment 200 depicted in FIGS. 8-13 is that the thin and somewhat delicate creases or reverse folds 250 that are located at the innermost diameters of central regions of the web portions 230 are protectively situated within the confines of the adjacent reinforcing coils 210, and are not exposed to rubbing or other engagements that can cause wear and failure of the hose length 200.

By ensuring that the folds 250 (which are defined by the radially innermost parts of the web portions 230) are located at a radial distance from the axis 79 that is farther than are the inner diameters of the reinforcing coils 210 from the centerline, the hose 200 is assured of having an inner diameter unobstructed by the creases or reverse folds 250 of the web portions 230. This arrangement may be advantageous in ensuring that radially inwardly extending web portions 230 do not obstruct a desired flow through a central portion of the hose 200 of breathing gas or the like.

However, by forming the web portions 230 so that they are longer than the radial distance between the outer and inner diameters of the reinforcing coils 210, the hose length 200 can be provided with a capability to extend to a longer fully extended length than if the web portions 230 are kept shorter than the distances between the outer and inner diameters of the reinforcing coils 210. In some applications, this arrangement (not specifically shown) of providing relatively lengthy web portions 230 that cause the creases or reverse folds 250 to extend further radially inward toward the axis 79 than the locations of the inner diameters of the reinforcing coils 210, may be deemed desirable in that it permits relatively lengthy extensions of the hose length 200 when it is necessary to stretch or elongate the hose length 200 to a greater extent than is depicted in FIGS. 12 and 13 for either of the two variants.

Except for the differences explained above that have to do with the web portions 230 extending radially inwardly as opposed to the web portions 130 extending radially outwardly, such information as presented above concerning the method of manufacture of the hose length 100 may be substantially all applicable to the method of manufacture of the hose length 200.

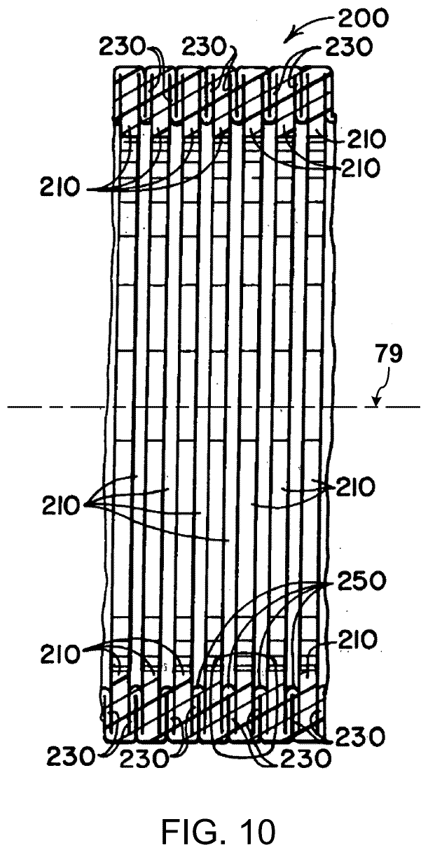

Both variants of the hose length 200 depicted in FIGS. 8-13 have uniform sized reinforcing coils 210 that are formed by a bead or rib of thermoplastic material that may be extruded by or from a conventional extrusion apparatus (not specifically shown) such as is commonly used in the formation of helically reinforced thermoplastic hose. However, it may be that the solid reinforcing coils 210 of the variant of the hose length 200 depicted in FIGS. 10-12 are extruded using an extruder configured to generate such a reinforcing coil 210 of solid cross-section, while the hollow reinforcing 210 coils of the variant of the hose length 200 depicted in FIG. 13 are extruded using an extruder configured to generate such a reinforcing coil 210 of hollow cross-section.

The reinforcing coils 210 are typically formed by causing a freshly extruded bead or rib of thermoplastic material (whether solid or hollow) to be helically wrapped about a spinning mandrel. In the hose length 200 shown in FIGS. 8-11, it will be seen that the outer and inner diameters of the reinforcing coils 210 also define outer and inner diameters of the hose length 200 when the hose 200 assumes its minimum axial length.

Although the reinforcing coils 110 of the hose length 100 and the reinforcing coils 210 of the hose length 200 are depicted and discussed herein as being of uniform diameter and as being formed from an extruded bead of thermoplastic material that has a particular cross-section, features of the present invention can be advantageously incorporated into and utilized by alternate embodiments of the hoses 100 and 200 (regardless of whether the reinforcing coils are of solid cross-section or are hollow) that taper because their reinforcing coils 110 and 210, respectively, are of progressively larger or progressively smaller diameters, and/or that have various other cross-sectional configurations.

Although each of the hose lengths 100 or 200 may be formed in a variety of ways, a preferred manufacturing technique calls for the thin web or wall 130 or 230 to be extruded in a tape-like form substantially concurrently with, but separately from, the extrusion of a bead or rib that forms the coils 110 or 210, respectively.

During manufacture of the hose 200, it is preferred that the coils 210 are helically wound about a spinning mandrel (not specifically shown) to form the helix 220 as a uniformly spaced helical array, and that the tape-like thin web or wall 230 is overlaid atop the helix 220 of spaced coils 210 so that opposite edge regions of the thin tape-like web 230 rest on the outermost diameters of two adjacent pairs of the reinforcing coils 210, so that a central region of the tape-like web 230 extends or bridges between each pair of adjacent coils 210, as is best seen in the hose-extended views of FIGS. 12 and 13. As the positioning of the tape-like thin web 230 to overlie adjacent pairs of the coils 210 takes place, the freshly extruded thermoplastic materials that form the coils 210 and the web 230 are still hot and quite tacky, hence edge regions of the web 230 that engage outer diameter regions of the coils 210 bond or weld and become as one, thereby defining the hose 200 as a unified thermoplastic structure.

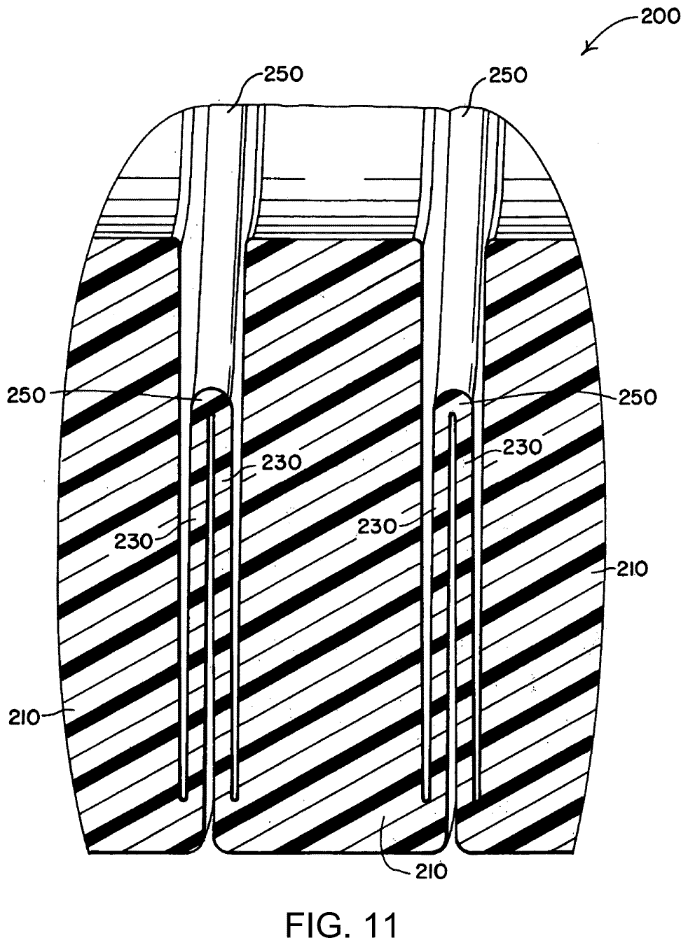

With the flexible, stretchable, crush-resistant hose 200 is in the fully axially contracted condition depicted in FIGS. 8-11, the coils 210 of the helix 220 are situated relatively snugly side-by-side, thereby sandwiching radially inwardly extending portions of the thin plastic web or wall 230 therebetween, as is best shown in the enlarged sectional view provided by FIG. 11. The hose 200 has its minimal axial length when it is in its normal condition as depicted in FIGS. 8-11, but can also be stretched or extended as shown in FIGS. 12 and 13, which causes adjacent coils 210 of the helix 220 to separate, and causes the central region of the thin web or wall 230 to flatten out or “unfold” as is partially shown in FIGS. 12 and 13 for each of the two variants.

If, during stretching or extension, the hose 200 is caused to bend or deflect (from any of the linear or straight-line configurations that are depicted in FIGS. 8-13, the crush resistant character of the hose 200 will permit the bending or deflection to take place without significantly diminishing the inner diameter of the hose 200.

In preferred practice, lengths of hose 200 that are formed by the process described above are axially compressed (i.e., compressed along the axis 79) to their minimum axial length, and are then subjected to an annealing procedure which relieves stress that may have built up in the materials of the hose 200 during production. When annealing under such axial compression is completed, stress within the materials of the hose 200 is relieved, and the resulting lengths of hose 200 always normally tend to return to their minimal length condition.

Such annealing has been found to enhance the stretchability and flexibility of the hose 200 without diminishing its crush resistance, and thereby serves to avoid the problems of stiffness that are characteristic of many prior art crush resistant hoses. This annealing process modifies the orientation of the molecules of thermoplastic that forms the reinforcing coils 210 of the helix 220 and the thin wall or web 230 that extends between the coils 210 of the helix 220.

As the heating and controlled cooling of the annealing process is completed with the hose 200 in its minimal axial length condition, the molecules of the materials of the coils 210 and the web or wall 230 relax and take on a new orientation with a memory of that minimal axial length condition as the “normal condition” to which the completed hose 200 will normally return when released from the imposition of external forces thereon (including the force of gravity). And, because stress is substantially absent from the hose 200 when the coils 210 of the hose 200 are side-by-side compressing the radially extending web or wall portions 230 therebetween in this normal condition, the hose 200 resists extension only when, and to the extent that, the hose 200 is elongated due to the exertion of an external force to stretch the hose length 200.

Stated in another way, the annealing process to which the hose 200 is subjected allows the hose 200 to exhibit a greater degree of flexibility and an ease of being stretched than are exhibited by other hose products, and enables the hose 200 to, in effect, provide a “strain relief” between medical delivery equipment (not shown) that typically is connected to one end region of a length of the hose 200, and a patient's facial or nasal mask (not shown) that typically is connected to an opposite end region of the same length of hose 200.

Yet another benefit of the annealed and stress-relieved hose 200 (i.e., relieved of stresses that were introduced during the manufacture of the hose 200 during such annealing) is that the hose 200 does not take a set shape (i.e., does not take on a configurational memory to which the hose 200 seeks to return) when deflected or bent in any one direction or orientation for a lengthy period of time.

Another objective of the annealing process to which the hose 200 is subjected is to diminish torsional stiffness of the resulting hose. Again, torsional stiffness is defined as how much twisting force is transmitted through the hose 200 before it “breaks away” into an arc or spiral that will absorb additional twisting force when one end is held securely to a fixed point. Again, this could also be regarded as the “twisting yield point,” as is explained above in conjunction with the hose 100.

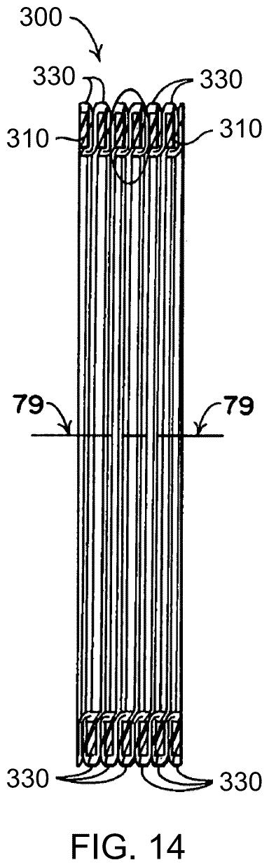

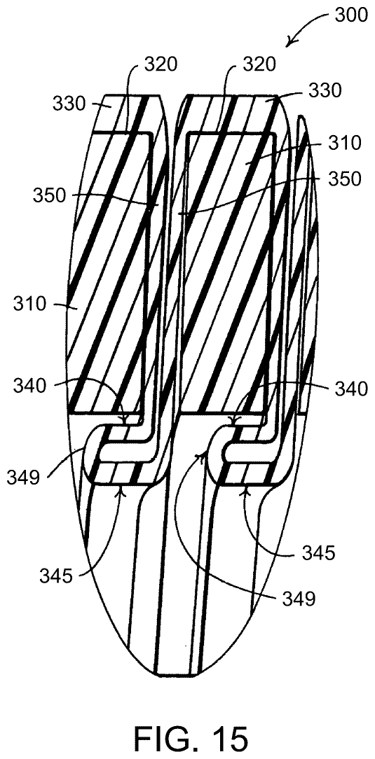

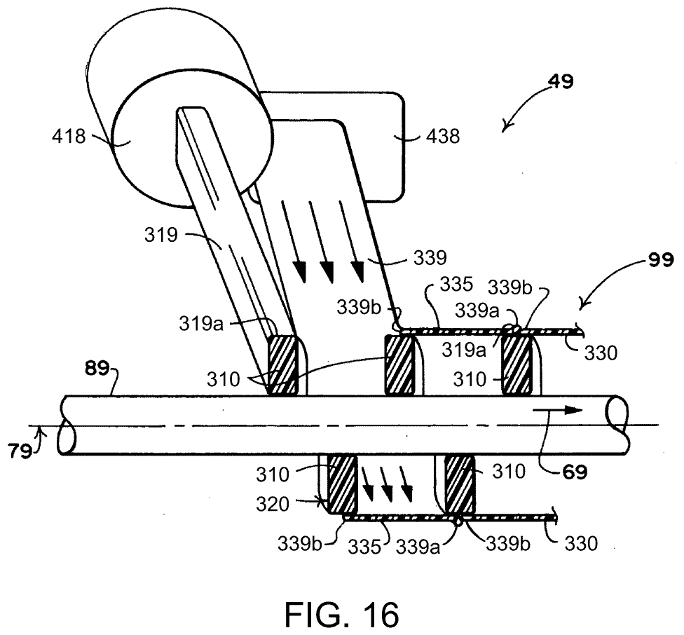

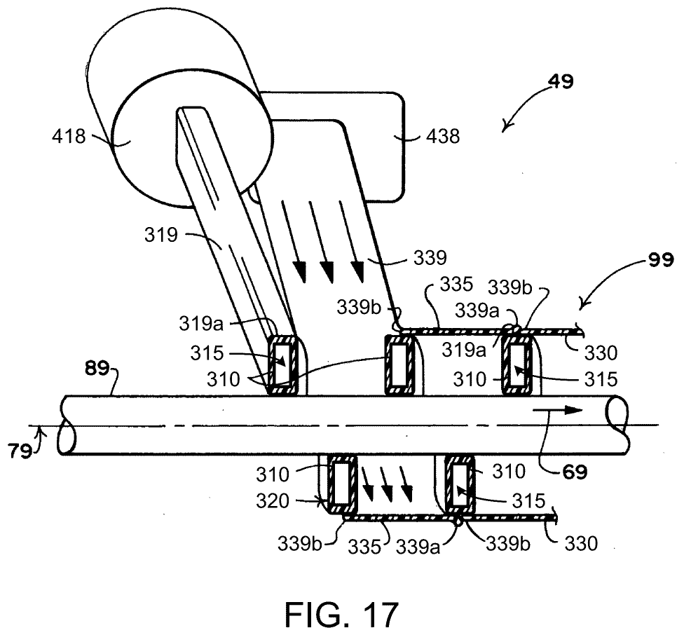

Referring to FIGS. 14-17, both of two variants of a short length of flexible, stretchable, crush resistant hose is indicated generally by the numeral 300. In FIGS. 14 and 15, portions of the length of hose 300 are shown in a fully axially retracted (or axially compressed, as the case may be) condition to what is referred to as a minimal axial length. In FIGS. 16 and 17, portions of each of the two variants of the length of hose 300 are shown in a fully axially extended condition during initial stages of the production of the hose 300 in which extruded thermoplastic materials are being helically wound together to begin the formation of the hose 300.

Turning more specifically to FIGS. 14-15, an interesting feature of the hose length 300 is the manner in which the thin outer wall or cover 330 extends inwardly between adjacent ones of the reinforcing coils 310. In this way, the hose length 300 has a structure somewhat similar to that of the hose length 200. However, in the hose length 300, innermost portions 340 and 345 of the thin outer wall or cover 330 fold together to extend substantially parallel to each other and to the axis 79, and to underlie the reinforcing coils 310 when the hose length 300 is axially retracted to its minimal length, as best shown in FIGS. 14-15. Thus, the portions 340 and 345 can be seen to come together in a reverse turn or fold 349 so the portions 340 and 345 overlie each other as they extend in parallel together.

A characteristic of the hose length 300 that is produced is the behavior of the hose length 300 when axially extending and retracting between an axially extended mode and the minimal axial length retracted mode (best shown in FIGS. 14-15). The hose length 300 has something of a snap-action as it is axially extended, and as it axially retracts, due to the innermost portions 340 and 345 folding to, and unfolding from, the overlying relationship shown in FIGS. 14-15.

In effect, the hose length 300 essentially seems to “pop” as it snaps from an axially retracted length to an axially extended length, and back to its axially retracted length. This provides quite a unique and noticeably pleasant sensation when one pulls on opposite ends of the hose length 300 to axially extend the hose length 300, and then releases the force that was exerted on the hose length 300 to cause the hose length 300 to be axially extended, whereupon the hose length 300 is allowed to axially retract due to the “memory” that has been instilled into it during a stress reduction procedure in which the hose length 300 was subjected to being annealed while the hose length 300 was axially compressed to its minimal axial length depicted.

FIGS. 16 and 17 schematically depict a hose production station 49, and a method of hose production that takes place at the hose production station 49 which causes substantially continuous production of a stretch hose 99 of either of the two variants on a mandrel 89 that rotates about the axis 79. The hose length 300 may be a cut off discrete length of the continuous hose 99, and extends substantially concentrically about the axis 79.

This hose production method includes separate but concurrent extrusions from a nozzle 418 of a continuous, solid, strand-like bead 319 of thermoplastic material, and from a nozzle 438 of a continuous, narrow, yet wide, tape-like web 339 of thermoplastic material. The nozzles 418 and 438 represent any of a wide variety of conventional extruder equipment that is suitable to heat and extrude thermoplastic material in a tacky state that permits the freshly extruded thermoplastic material to bond to other heated, tacky thermoplastic material.

More specifically, both the bead 319 and the web 339 have cross-sections that are defined by the extruder nozzles 418 and 438, respectively, as the bead 319 and the web 339, respectively, are extruded. For the variant depicted as being produced in FIG. 16, the nozzle 418 may be selected to generate the bead 319 to have a uniform and solid cross-section. In contrast, the variant depicted as being produced in FIG. 17, the nozzle 418 may be selected to generate the bead 319 to have a hollow cross-section such that a secondary passage 315 is formed therein.

Regardless of which the two variants is being produced, the bead 319 and the web 339 are fed toward and are helically wrapped about the rotating mandrel 89 to form the continuously extending hose 99 which precesses (during production of the hose 99) along the rotating mandrel 89 in a direction indicated by the depicted arrow 69. Precession of the hose 99 along the mandrel 89 in the direction of the arrow 69 is primarily due to an application of force to the hose 99 exerted by equipment (not shown) located downstream from the hose production station 49.

More specifically, the bead 319 is wrapped helically about the rotating mandrel 89 to form a helix 320 of substantially equally spaced reinforcing ribs or coils 310 for the hose 99 that is formed about the mandrel 89. The web 339 is wrapped helically about the helix 320 (and thereby, is wrapped helically about, and at a distance from, the rotating mandrel 89) to form a continuous cover or outer wall 330 of the hose 99. As the freshly extruded (and likely still tacky) bead 319 and the freshly extruded (and also likely still tacky) web 339 are brought into contact with each other, they bond almost immediately—indeed, substantially instantaneously.

As depicted, the web 339 has a leading edge region 339a and a trailing edge region 339b. As also depicted, for each wrap of the web 339, the leading edge 339a very slightly overlaps and bonds almost instantly to the trailing edge 339b of the previously installed wrap of the web 339 (which is why the leading edge regions 119a are shown located radially outwardly from the trailing edge regions 119b). And, as further depicted, both of the leading edge region 339a and the trailing edge region 339b of each newly installed wrap of the web 339 are positioned to engage outermost peripheral regions 319a of an adjacent pair of the reinforcing ribs 310. Thus, the reinforcing coils 310 are formed on the mandrel 89 prior to (usually just before) the web 339 being wrapped about the rotating mandrel 89—so that opposed edge regions 339a, 339b of the tacky web 339 can be overlaid to rest upon (and to bond substantially immediately with) peripheries 319a of the reinforcing coils 310.

It should be noted that, although FIGS. 16 and 17 show lines of demarcation that separate the engaged leading edge regions 339a and trailing edge regions 339b, the fact that these edge regions directly engage each other means that these edge regions bond substantially instantaneously. Such instantaneous bonding leaves no such lines of demarcation, and no such outwardly turned formations (or tell-tale formations of any kind) where the edge regions 339a and 339b overlap. The overlapping edge regions 339a and 339b essentially melt smoothly together as they bond with a peripheral portion 319a of one of the reinforcing ribs 310.

It should also be noted that, although central portions 335 of each wrap of the web 339 are depicted in FIGS. 16 and 17 as extending substantially concentrically about the axis 79, during formation of the hose 99, it may be that central portions 335 actually sag radially inwardly toward the axis 79. Such a sagging of the central portions 335 may bring the central portions 335 into engagement with the mandrel 89. When the newly formed hose 99 is pulled in the direction of arrow 69, such sagging central portions 335 may drag on the mandrel 89, and this may contribute to the formation of the parallel-extending formations 340 and 345 that are best shown in FIG. 15 being formed as the hose 99 is pulled along and off of the rotating mandrel 89.

Following such formation of the hose 99 through such a combining of the bead 319 and web 339, the hose 99 may be fully axially compressed. In so doing, and referring back to FIGS. 14-15 in addition to FIGS. 16-17, parts 350 of the central portions 335 that bridge between adjacent pairs of the reinforcing ribs 310 are sandwiched therebetween. Also, centermost parts of the central portions 335 form the fold or reverse-turn bend 349, and fold together to define the portions 340 and 345 that extend in parallel with each other and with the axis 79, as previously discussed.

Stated more simply, as the hose 99 is axially compressed, the central portions 325 assume the configuration depicted most clearly in FIG. 15, and the fold 349 is formed together with the parallel-extending parts 340 and 345. This fold-over configuration of the fold 349 together with the parts 340 and 345 is a result of the web being significantly softer than the reinforcing rib helix 320—and, the configuration of this fold-over has been found to occur quite automatically and naturally without need for any other exertion of force or effort. The lengths of the parallel-extending parts 340 and 345 are directly related to the initial pitch with which the hose 99 is produced. Stating this relationship in another way, the wider the web 339, the longer are the parts 340 and 345.

Discrete lengths of the hose 99 (i.e., one or more of the hose lengths 300) may be cut from the hose 99. Each such hose length 300 may be axially compressed to the minimum axial length, and may then be annealed while so axially contracted to diminish, minimize or eliminate stresses that may have been introduced by the aforedescribed process of forming the hose 99. A length of hose that is so annealed while being so axially compressed will have a uniform spring force measured along the axis of the hose.

Although the invention has been described in its preferred form with a certain degree of particularity, it is understood that the present disclosure of the preferred form has been made only by way of example, and that numerous changes in the details of manufacture or construction and/or in the combination and arrangement of parts may be resorted to without departing from the spirit and scope of the invention as hereinafter claimed.

What is claimed is:

1. A method of forming a flexible, stretchable, crush resistant axially extending hose comprising:
providing coils entirely of thermoplastic material to form a continuous and hollow helix;
providing a thin, narrow, elongate web of thermoplastic material that extends between adjacent coils of the helix and has edge regions welded to adjacent ones of the coils to form a single continuous wall with the web having a radially inwardly extending, centrally located fold situated between adjacent ones of the coils; and
subjecting the hose to an annealing process while axially compressing the hose so that molecules of the thermoplastic material forming the coils of the helix and the thin elongate web are relaxed such that stress is substantially absent from the hose when the coils of the helix are close together.

2. The method of claim 1, wherein the annealing process is completed while the hose is axially compressed to a minimal axial length condition wherein the coils of the helix are side-by-side snugly sandwiching radially inwardly extending portions of the web therebetween to give the resulting hose a memory of the minimal axial length condition as a normal condition to which the hose will tend to return when released from external force influences.

3. The method of claim 2, wherein the hose is formed such that, when the hose is in the normal condition, portions of the web that extend radially inwardly define a reverse-direction crease at a location spaced radially further inward than the minimum inner diameter of the helix.

4. The method of claim 3, additionally including the step of utilizing the annealing process to set the reverse-direction crease.

5. The method of claim 2, wherein the thermoplastic materials selected to form the hose provide a stretch ratio of the length to which the hose can be stretched in comparison to the length of the hose in the normal condition that is at least 1.5:1.

6. The method of claim 2, wherein the hose is provided with spring tension that tends to cause the hose to retract to the normal condition, and that builds up in the hose only when the hose is stretched, wherein the spring tension being attributable to the thermoplastic material forming the web in proportion to the spring tension attributable to the thermoplastic material forming the coils of the support spiral is 25% to 50%.

7. The method of claim 2, wherein the hose is provided with spring tension that tends to cause the hose to retract to the normal condition, and that builds up in the hose only when the hose is stretched, wherein the spring tension being attributable to the thermoplastic material forming the web in proportion to the spring tension attributable to the thermoplastic material forming the coils of the support spiral being 25% to 90%.

8. The method of claim 1, wherein the coils of the helix are formed to have a generally rectangular cross-sectional configuration that defines both the maximum outer diameter of the hose, and the minimum inner diameter of the hose when the hose is in its normal minimal length condition.

9. The method of claim 1, wherein providing thermoplastic material to form the helix and providing thermoplastic material to form the web comprise providing the same thermoplastic material.

10. The method of claim 1, wherein:
providing thermoplastic material to form the helix comprises providing thermoplastic material selected from among polyvinyl chloride (PVC), thermoplastic urethane (TPU), polypropylene (PP), thermoplastic elastomer (TPE) and acrylonitrile butadiene styrene (ABS); and
providing thermoplastic material to form the web includes providing thermoplastic material selected from among PVC, TPU, PP, TPE and ABS thermoplastic.

11. The method of claim 1, wherein different thermoplastic materials are used to form the helix and the web, with the thermoplastic material forming the helix being selected to have a higher modulus of elasticity than that of the thermoplastic material forming the web.

12. The method of claim 1, wherein the thermoplastic materials selected to form the hose provide a spring constant effective when the hose is stretched that has a value of 5 N/m to 25 N/m, with these values being determined by the thickness of the web and the nature of the material selected to form the web.

13. A method of forming a flexible, stretchable, crush resistant axially extending hose, comprising:
helically winding newly extruded thermoplastic material to form the hose to have coils that form a continuous and hollow helix, and a thin, narrow, elongate web that extends between adjacent coils of the helix and has edge regions welded to adjacent ones of the coils to form a single continuous wall, wherein the web has a radially outwardly extending, centrally located fold situated between adjacent ones of the coils; and
annealing the hose while the coils of the helix are axially compressed to cause the molecules of the thermoplastic material forming the coils and the thin thermoplastic material forming elongate web to be relaxed such that stress is substantially absent from the hose when the coils of the helix are closer together.

14. The method of claim 13, wherein the annealing process is completed while the hose is axially compressed to a minimal length condition wherein the coils of the helix are side-by-side snugly sandwiching radially outwardly extending portions of the web therebetween.

15. The method of claim 13, wherein the hose is formed such that, when the hose is in the normal condition, portions of the web that extend radially outwardly extend radially further outward than the maximum outer diameter of the helix.

16. The method of claim 13, wherein:
the helix and the wall cooperate to define a primary passage through which a primary gas or liquid is able to be conveyed by the hose;
the hollow helix defines a secondary passage through which a secondary gas or liquid is able to be conveyed;
the primary gas or liquid flows through the primary passage and the secondary gas or liquid flows through the secondary passage in a common direction along the axial length of the hose; and
the secondary gas or liquid is to be mixed with the primary gas or liquid at a destination to which the hose extends, or the secondary gas or liquid serves to heat or cool the primary gas or liquid.

17. The method of claim 13, wherein:
the helix and the wall cooperate to define a primary passage through which a primary gas or liquid is able to be conveyed by the hose;
the hollow helix defines a secondary passage through which a secondary gas or liquid is able to be conveyed;
the primary gas or liquid flows through the primary passage and the secondary gas or liquid flows through the secondary passage in opposite directions along the axial length of the hose; and
the flow of the secondary gas or liquid comprises a return flow from a patient to which the flow of the primary gas or liquid is conveyed, or the secondary gas or liquid serves to heat or cool the primary gas or liquid.

18. A hose production method comprising:
concurrently and continuously extruding both a hollow strand-like bead of thermoplastic material, and a relatively wide, relatively thin, tape-like web of thermoplastic material having equidistantly spaced, continuously extending edge regions;
wrapping the freshly extruded bead around and in engagement with peripheral portions of a rotating mandrel to provide a substantially uniformly spaced array of reinforcing coils for a hose that is being formed so as to extend along an axis of the rotating mandrel;
helically wrapping the freshly extruded web about an outer surface of the helix that is radially furthest from the axis, with the equidistantly spaced edge regions of the wrapped web continuously contacting and substantially immediately bonding to portions of the outer surface of each adjacent pair of the reinforcing coils of the helix, and with each new helical wrap of the web having a leading one of the equidistantly spaced edge regions overlapping and bonding substantially immediately and continuously to a trailing one of the equidistantly spaced edge regions of a previous wrap of the web; and
annealing the hose while the hose is axially compressed to a minimal axial length to cause central portions of the web that extend between adjacent ones of the reinforcing coils to extend inward toward the central axis when the hose is subsequently axially compressed to the minimum axial length.

19. The hose production method of claim 18, further comprising cutting a discrete length of hose from the hose produced by the method.

20. The hose production method of claim 18, wherein annealing the hose while the hose is axially compressed to the minimal axial length diminishes such stress as may have been instilled in the discrete length of hose during formation.

21. The hose production method of claim 18, wherein annealing the hose while the hose is axially compressed to the minimal axial length relaxes molecules of the thermoplastic material such that stress is substantially absent from the hose when the hose is retracted to the minimal axial length.

22. The hose production method of claim 18, wherein the central portions define at least part of an interior diameter of the hose when the hose is retracted to the minimal axial length.

23. The method of claim 18, wherein:
the helix and the wall cooperate to define a primary passage through which a primary gas or liquid is able to be conveyed by the hose;
the hollow helix defines a secondary passage through which a secondary gas or liquid is able to be conveyed;
the primary gas or liquid flows through the primary passage and the secondary gas or liquid flows through the secondary passage in a common direction along the axial length of the hose; and
the secondary gas or liquid is to be mixed with the primary gas or liquid at a destination to which the hose extends, or the secondary gas or liquid serves to heat or cool the primary gas or liquid.

24. The method of claim 18, wherein:
the helix and the wall cooperate to define a primary passage through which a primary gas or liquid is able to be conveyed by the hose;
the hollow helix defines a secondary passage through which a secondary gas or liquid is able to be conveyed;
the primary gas or liquid flows through the primary passage and the secondary gas or liquid flows through the secondary passage in opposite directions along the axial length of the hose; and
the flow of the secondary gas or liquid comprises a return flow from a patient to which the flow of the primary gas or liquid is conveyed, or the secondary gas or liquid serves to heat or cool the primary gas or liquid.
